(19) United States
(12) Patent Application Publication
(10) Pub. No.: US 2017/0109863 A1
(43) Pub. Date: Apr. 20, 2017

(54) Pixel Mapping Systems and Processes Using Raster-Based and Vector Representation Principles

(71) Applicant: Mathieu Jacques, Montreal (CA)

(72) Inventor: Mathieu Jacques, Montreal (CA)

(21) Appl. No.: 15/297,581

(22) Filed: Oct. 19, 2016

Related U.S. Application Data
(60) Provisional application No. 62/243,480, filed on Oct. 19, 2015.

(51) Int. Cl. G06T 3/40

(52) U.S. Cl. CPC G06T 3/4007; G06T 11/001

(57) ABSTRACT

A pixel mapping method for transferring an electronically generated image onto a physical substrate upon which a plurality of lighting elements are applied, the method comprising changing the control points associated with each lighting element by computing the Bezier segments interconnecting all of the control points by interpolating two or more control points for each original control point, locating a two-dimensional position of each lighting element, integrating the Bezier segments using a numerical approximation algorithm to determine a new two-dimensional position of each lighting element, and storing the new two-dimensional positions of the lighting elements. Thereafter, a DMX control protocol is initiated by computing a pixel position for each lighting element of a source media by interpolating its previously computed position relative to the actual dimensions of the media, applying the RGB color on the source media at each interpolated pixel position, and writing the colors to a DMX buffer.

### CROSS-REFERENCE TO RELATED APPLICATIONS

This application claims the priority, under 35 U.S.C. §119, of U.S. Provisional Patent Application Ser. No. 62/243,480, filed on Oct. 19, 2015, the entire disclosure of which is hereby incorporated herein by reference in its entirety.

### STATEMENT REGARDING FEDERALLY SPONSORED RESEARCH OR DEVELOPMENT

Not applicable.

### FIELD OF THE INVENTION

The present invention lies in the field of controlling lighting elements, especially dimmable or color-mixable light-emitting diodes (“LEDs”) that may be arranged in a physical configuration that allows the LEDs to follow a desired pattern that may be intended to mimic or accent an architectural installation, theatrical scene, or another type of unorthodox (most advantageously, non-rectangular) configuration for the purpose of creating a lighting effect or displaying some type of media on an arrangement of lighting elements.

### BACKGROUND OF THE INVENTION

Hardware-based and software-based solutions to the problem of Pixel Mapping have become increasingly sophisticated over the last few years in their approach to using multiple output protocols to allow a user to work with many different kinds of lighting elements. This trend has occurred hand in hand with a great deal of improvement in the miniaturization and increased brightness of LEDs and their associated support mechanisms. However, one aspect in the world of LED development that has not been adequately addressed by Pixel Mapping products is the popularity of LED Pixel Tape. This type of product offers individually controllable LEDs on a flexible substrate that can bend around curved objects, and thus assume a large number of non-rectangular shapes. At a larger scale, it has recently become popular to take individually controlled nodes, comprised of color-mixable LEDs that are connected by flexible wiring, and mount them in a shape that is not a straight line or a collection of straight lines to form a grid.

A user may wish to wrap a segment of the LED flexible tape around a concrete pillar, such as a barbershop pole, for example. Or, a user may wish to deploy larger dots, which are connected by flexible wire, in a long curve that follows, for example, the arc of a bridge span. None of these types of applications is addressed well by simply referencing the isometrically spaced locations where a pixel might be positioned in a rectangle that has coordinates in an X and Y pair of axes, unless the precision of their placement was many digits to the right of the decimal point. The disadvantage of such precision is the drudgery and imprecision of creating such a pixel map, even in a grid that is thousands of elements wide by thousands of elements tall. The larger the number of potential points where an LED element could be positioned, the slower and more tedious it is to draw such a curve using standard raster image tools. After drawing such a curve, editing it for responsiveness to changing realities in the real world architecture presents an even greater challenge.

In this particular field, the number of possible elements that can be controlled has been growing to the point where one can mimic a video screen, although often at lower resolutions than that which is provided when the technology originates in the realm of traditional video displays. It is not advantageous at large scales to try and replace such video technology with LEDs that are controlled in a manner consistent with lighting fixtures for theatrical use. The amount of data needing to be manipulated and sent to all of the individual LED elements in such an array is too complex and the wiring is unwieldy, especially in comparison to solutions designed for video display. Yet, it still can be a useful approach when attempting to place imagery onto display systems that are built in unusual arrangements, such as irregular shapes, non-standard proportions of height and width, and round objects like circles and ovals, etc. The process of transferring an image (or images) that is electronically generated onto a physical display that is of a different shape and proportion than the original is often referred to in the industry as “Mapping.” It may be further identified as “Pixel Mapping” when it applies to discrete emitters of light that are in some way analogous to the tiny individual elements that make up the smallest indivisible element of a picture image.

Currently, numerous products exist that allow a user to perform Pixel Mapping for applications such as live events, an architectural installation that is pre-recorded or perhaps interactive with a live viewer, and a luminous sculpture, for art's sake. Titles such as PHILIPS' Light System Manager and its associated family of products are well known in the industry for allowing a series of shapes to be specified that describe the deployment of a series of LEDs in a grid, such as a square or rectangle, a triangle, or several other shapes. Although the technical disclosure of this particular technology anticipates the ability to draw with LEDs, in a grid wise fashion, to create any kind of shape, including a curvilinear one, it falls short of un-tethering the user from a grid-based paradigm and, therefore, any attempt at simulating a curved object will result in a highly pixelated image. Using this existing technology, one can build objects in a stair-step fashion but the more objects there are to control, the harder it is to edit this grouping. Accordingly, a trade-off is created between the desirability of high-resolution images and the necessity of having to spend countless hours placing those LED elements carefully on a grid whose spacing is more or less in keeping with a minimum distance between the elements.

Other Mapping products in common use within the industry employ complicated algorithms to deform a standard grid in some n-dimensional space that allows a viewer to see projected imagery in a particular way after the media it contains has been stretched, shrunk, pushed and/or pulled, according to the geometry of the surface receiving the image. This is done on the server side, to compensate for the distortion inherent in using a digital projector that is being aimed at a normal angle to a surface that is not a flat rectangle. This kind of Mapping is a manipulation of the video image to compensate for a particular display format, which provides great enhancements to the process of deploying media via a projector, but it does not relate well to LEDs and other emissive light sources.

At no time in the prior art has the problem been solved of how to control large collections of LEDs that are both linear (particularly with respect to their physical makeup and the way they are electrically interconnected) and, at the same time, curvaceous, in the way they are arranged to the eye of the observer.

Thus, a need exists to overcome the problems with the prior art systems, designs, and processes as discussed above.

### SUMMARY OF THE INVENTION

The systems, apparatuses, and methods described provide a Pixel Mapping system and process that overcome the hereinafore-mentioned disadvantages of the heretofore-known devices and methods of this general type and that combines a raster approach with a vector-based representation and utilizes the most advantageous aspects of each approach in an inventive way. The systems, apparatuses, and methods utilize a vector-based representation of a plurality of lighting fixtures, such as LED strips, for example, to allow automatic positioning of individual lighting elements (spaced on regular intervals within the linear element), as they are located in the larger two- or three-dimensional spatial representation of the physical object being modeled. The linear elements may be, for example, straight lines, closed loops, or open-ended Bezier curves, which can then be manipulated according to their inherent control points according to well-known mathematical relationships. These types of structures are used to effectively create realistic shapes that model naturally occurring shapes and those prevalent in architecture.

The systems, apparatuses, and methods disclosed herein utilizes two very useful features of vector-based graphical elements: their inherent ability to be edited and scaled and the ease with which they can be repositioned. Accordingly, these elements can be changed easily, so as to accommodate higher- and lower-resolution technologies on the same map. The systems, apparatuses, and methods disclosed herein also capitalize on raster based graphic technology by setting all the vector images in front of a positioning and sizing grid that relates to the media that will ultimately be mapped to the lighting elements that are being controlled.

In order to efficiently utilize vectors using a computer comprising multiple central processing units (CPUs), a special memory representation based on immutability has been developed and is disclosed herein. The term “immutable” means the data is fixed and can only be read. Each time a vector changes (for example, by the dragging of a control point by the user), the system and process of the invention re-samples, using a numeric integration method (e.g., using Simpson's Rule), the new position of the vector (or vectors) that comprise the location of the LED strip in order to extract the LED positions. Thereafter, immutable structures are created in the memory to store these positions along with the corresponding DMX addresses and a placeholder for the RGB color. Immutable structures are then sorted in the order in which the color is extracted from the media source, that is, from top-left to bottom-right. Accordingly, the modern CPU cache is efficiently used. One key property of immutable structures is that they can be processed efficiently in parallel because no synchronization is needed between the CPUs to update the memory, making it very suitably adapted for a multi-CPU architecture.

The raster image that allows positioning of the LEDs or other lighting elements may be unique for each project or application, or it may be one of a plurality of raster images that are dedicated to various subsets of the project as a whole, so as to allow the user to selectively feature different media or different areas of the system being controlled. In one exemplary embodiment, those arrangements and the grids they are placed in front of are referred to as “stages.” An element may be controlled by more than one stage, if desired, and certain rules may be applied as determined by the user in advance to referee any conflicting instructions. Alternatively, in other exemplary embodiments, the user may be provided with a number of options for the merging of two or more stages, thus providing more flexibility than just implementing a “stage 1” or a “stage 2.” For example, a plurality of stages can be combined in a way similar to a photo or video layer compositing technique. Accordingly, instead of overwriting a prior stage (which may still be included as an option) with a different stage, a user may stipulate that a certain stage is to be merged with another by way of, for example, alpha channel compositing, or by the brighter of the two wins, darker of the two wins, additive or subtractive mixes, etc.

With the foregoing and other objects in view, there is provided a pixel mapping method for transferring an electronically generated image onto a physical substrate upon which a plurality of lighting elements, wherein the method comprises changing a plurality of control points associated with each of the plurality of lighting elements by computing the Bezier segments interconnecting all of the plurality of control points by interpolating two or more control points for each original control point, whereby each Bezier segment is computed using at least a start point, an end point, and two additional control points in order to smooth a resulting curve, locating a two-dimensional position of each of the plurality of lighting elements based upon an assumption that the lighting elements are positioned at equal distances from each other, integrating the Bezier segments by using a numerical approximation algorithm to determine a new two-dimensional position of each of the plurality of lighting elements, storing the new two-dimensional positions of the plurality of lighting elements, and initiating an output DMX control protocol by computing a pixel position for each lighting element of a source media by interpolating the lighting elements' previously computed pixel position relative to actual dimensions of the media, applying RGB colors on the source media at each interpolated pixel position, and writing the colors to a DMX buffer.

In accordance with a mode of an exemplary embodiment thereof, the plurality of lighting elements are comprised of light-emitting diodes (LEDs).

In accordance with another mode of an exemplary embodiment thereof, the numerical approximation algorithm utilized in the integrating step is derived from Simpson's Rule.

In accordance with a further mode of an exemplary embodiment thereof, the computing of the pixel position for each lighting element is performed using a fast linear interpolation method.

In accordance with an added mode of an exemplary embodiment thereof, the method further comprises applying a transformation to the RGB color prior to writing the colors to the DMX buffer by using a conversion algorithm to obtain a RGBW or White color format.

With the foregoing and other objects in view, there is also provided a method for updating a pixel map for transferring an electronically generated image onto a physical substrate upon which a plurality of lighting elements are applied, wherein the method comprises determining that a modification of a position of at least one lighting element of the plurality of lighting elements has occurred and changing a plurality of control points associated with each of the plurality of lighting elements by computing the Bezier segments interconnecting all of the plurality of control points by interpolating two or more control points for each original control point, whereby each Bezier segment is computed using at least a start point, an end point, and two additional control points in order to smooth a resulting curve, locating a two-dimensional position of each of the plurality of lighting elements based upon an assumption that the lighting elements are positioned at equal distances from each other, and storing the new two-dimensional positions of the plurality of lighting elements.

With the foregoing and other objects in view, there is further provided a method for updating a pixel map for transferring an electronically generated image onto a physical substrate upon which a plurality of lighting elements are applied, wherein the method comprises modifying a position of at least one lighting element of the plurality of lighting elements, determining that the modification of the position of the at least one lighting element requires the pixel map to be updated, and changing a plurality of control points associated with each of the plurality of lighting elements by computing the Bezier segments interconnecting all of the plurality of control points by interpolating two or more control points for each original control point, whereby each Bezier segment is computed using at least a start point, end point, and two additional control points in order to smooth a resulting curve, locating a two-dimensional position of each of the plurality of lighting elements based upon an assumption that the lighting elements are positioned at equal distances from each other, integrating the Bezier segments by using a numerical approximation algorithm to determine a new two-dimensional position of each of the plurality of lighting elements, and storing the new two-dimensional positions of the plurality of lighting elements.

In accordance with a mode of an exemplary embodiment thereof, the method further comprises using the resulting updated pixel map to create a resulting lighting effect or image presented by a source media by initiating an output DMX control protocol, which comprises computing a pixel position for each lighting element of the source media by interpolating its previously computed pixel position relative to actual dimensions of the media, applying RGB colors on the source media at each interpolated pixel position, and writing the colors to a DMX buffer.

In addition, the present disclosure provides several other advantageous and inventive features that facilitate the use of the Pixel Mapping system and process disclosed herein. For example, according to an exemplary embodiment, provided is a library of media elements that can be chosen for replay on a plurality of stages. This library allows the user to choose from many sources of content that include, but are not limited to, video files, still images, streaming video sources, cameras, output from other computer software programs on the same computer, captured video coming in from an external source, text crawls, and effects engines, etc. Integration of a network interface (e.g., Network Device Interface (NDI™) by NewTek™) allows for receiving live video streams from over a network. Full high-definition (HD) video and 4K ultra high definition video may be supported. Further, video inputs may be flipped horizontally and vertically, which is particularly useful when a video card sends video in a flipped orientation. The library has convenient-to-use transcoding functions that allow the user to optimize file formats for smooth replay.

In another example, the present disclosure provides a scheduler module, with both real-time and astronomical clock based event timing. The scheduler window provides a number of functions that include, for example, the ability of the user to specify different lists of activities that will play media in some predefined order, at predetermined times on a daily, weekly, or monthly basis. The scheduler module has a different list of playable selections and scheduled events for each stage that is part of the overall project.

In a further example, the present disclosure provides the ability to take control of the playback functionality remotely, by way of a hook that is exposed to the outside lighting controllers using any standard and suitable protocol, such as DMX512, Art-Net, sACN, Open Sound Control (OSC), or similar. These protocols allow signals from a conventional lighting controller, such as a device typically used to control the lighting for theatre, concerts, art or architectural installations, televised special events, etc., to flow into the software embodiment, and direct how the controller operates. This taking of control by a remote console could, for example, allow for the mixing of different layers of media elements in a real-time mash-up, or allow the user to filter colors in the media being played preferentially, or to speed up or slow down media playback. Other aspects of the real-time operation of the software could be linked to remote operation as well.

In yet another inventive feature, the present disclosure provides for the ability to live mix different media components using the manual selection of desired objects from a media library, and allows a user to cross-fade between them, in both auto-timed and manually-configured proportional mixture positions.

Although the systems, apparatuses, and methods are illustrated and described herein as embodied in a software-based Pixel Mapping system and process using both raster based and vector representation principles, it is, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems, apparatuses, and methods.

Additional advantages and other features characteristic of the systems, apparatuses, and methods will be set forth in the detailed description that follows and may be apparent from the detailed description or may be learned by practice of exemplary embodiments. Still other advantages of the systems, apparatuses, and methods may be realized by any of the instrumentalities, methods, or combinations particularly pointed out in the claims.

Other features that are considered as characteristic for the systems, apparatuses, and methods are set forth in the appended claims. As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one of ordinary skill in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the systems, apparatuses, and methods of the invention that are regarded as novel, it is believed that the systems, apparatuses, and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not necessarily true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a flow chart that provides an overview of an exemplary embodiment of the steps of a Pixel Mapping process;

FIG. 2 is a schematic view of an exemplary embodiment of a stage strip display as depicted in a graphical user interface;

FIG. 3 is a schematic view of an exemplary embodiment of a media library as depicted in a graphical user interface;

FIG. 4 is a schematic view of an exemplary embodiment of a schedules screen as depicted in a graphical user interface;

FIG. 5 is a schematic view of an exemplary embodiment of a live control screen as depicted in a graphical user interface;

FIG. 6 is a schematic view of an exemplary embodiment of a remote control screen as depicted in a graphical user interface;

FIG. 7 is a flow chart that provides an exemplary embodiment of an overview of steps of certain live control functions; and

FIG. 8 is a flow chart that provides an exemplary embodiment of an overview of the steps of certain scheduler functions.

### DETAILED DESCRIPTION OF THE INVENTION

As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one skilled in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the features of the systems, apparatuses, and methods that are regarded as novel, it is believed that the systems, apparatuses, and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems, apparatuses, and methods will not be described in detail or will be omitted so as not to obscure the relevant details of the systems, apparatuses, and methods.

Before the systems, apparatuses, and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

It will be appreciated that embodiments of the systems, apparatuses, and methods described herein may be comprised of one or more conventional processors and unique stored program instructions that control the one or more processors to implement, in conjunction with certain non-processor circuits and other elements, some, most, or all of the functions of the devices and methods described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system or programmable device. A “program,” “software,” “application,” “computer program,” or “software application” may include a subroutine, a function, a procedure, an object method, an object implementation, an executable application, an applet, a servlet, a source code, an object code, any computer language logic, a shared library/dynamic load library and/or other sequence of instructions designed for execution on a computer system.

Herein various embodiments of the systems, apparatuses, and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

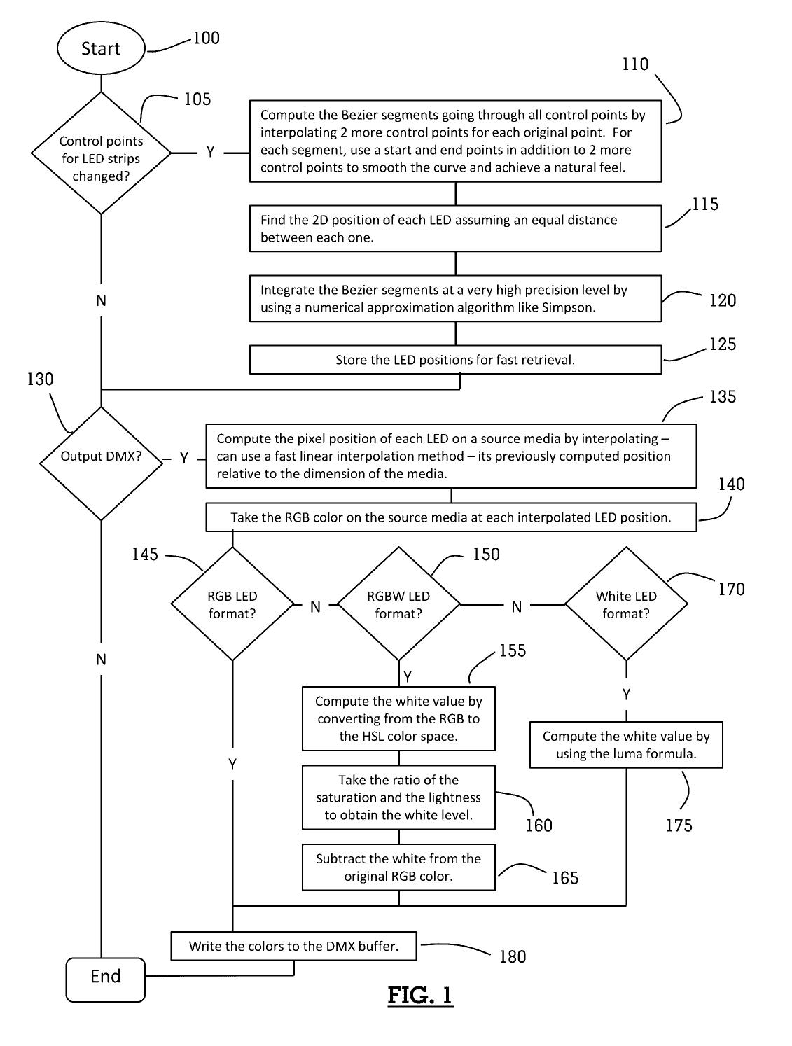

Described now is an exemplary embodiment of the present invention. Referring now to the figures of the drawings in detail and first, particularly to FIG. 1, there is depicted a flow chart of an exemplary embodiment of the Pixel Mapping process. The result of this Pixel Mapping process is the positioning of a number of individually controllable LED elements upon a substrate, wherein the substrate may be in the form of any surface to which the LED elements can be applied, including the facades and contours of production stages, buildings, landmarks and other architectural structures.

As described in detail below, the Pixel Mapping system and process is implemented using a specialized software application that is executed by one or more computing devices. Such computing devices may comprise any device that is capable of executing a software application with memory and processing components of the device, receiving and transmitting data in real time across one or more networks, and displaying to an operator a graphical user interface according to the software application. Such devices may include, but are not limited to, mobile devices, tablets, personal computers (PCs), or any other type of computing device. The software application may be accessible through a downloadable copy that may be stored within a third-party computing device. Alternatively, the software application may be provided within a specific hardware-based solution that is developed specifically for the execution of the software application of the present invention. Such a hardware-based solution may also comprise a number of additional hardware and/or software system components (e.g., in a “bundle” offering) for implementing a lighting installation for which the software application of the present invention is intended to facilitate.

Regarding the types of LED lighting elements that are contemplated to be controllable by the systems and processes described herein, a brief digression into the current state of pixel-based LED technology may be deemed beneficial to the reader. The most common arrangement is a tape or ribbon-like format in which the individual LEDs appear in a line on a flexible substrate and can be wired in a configuration that allows power to flow to each LED in parallel, but the control data wire is in series, with each chip performing some operation on the data being sent through it to be manipulated meaningfully. The net effect is that each LED can be addressed and given its own distinct brightness level, or with mixtures of LEDs, a color profile that is a mixture of Red/Green/Blue, or Red/Green/Blue and White, for example. A protocol suitable for this configuration is known as WS2811, or WS2812(B). It uses three wires: power, data, and ground.

Another arrangement of LED elements that can be controlled by the systems and processes described herein may be referred to as “Pixel Dots.” In this configuration, rather than a flexible tape substrate that has a fixed spacing between the individual LED elements, individual LEDs are grouped together to produce a higher brightness. In other words, instead of there being an individual “atom” (i.e., the smallest unit of uniquely controllable LED material), “Pixel Dots” allow for the ability to have a “molecule” that is comprised of 3, 6, or 12 small LEDs, for example, and their wiring is adjusted slightly so that the data going to their group is all the same, and the next group on the chain receives its own data, and so forth. This multiplication factor makes it easy to use a 12V or 24V DC power source, instead of a 5V DC power source, which has certain advantages and a resulting brightness that makes this LED configuration particularly desirable for certain applications. Between each of the “Pixel Dots,” there is a flexible wiring harness of some length, typically a repeatable length that is consistent over a plurality of dots.

In a third example of an embodiment of LED arrangement that can be utilized in conjunction with the systems and processes described herein, a printed circuit board may be employed and a number of LEDs, such as those aforementioned WS2812 chips that could populate a tape segment, may be mounted on the circuit board in a grid, circle, or some other desirable configuration. These LED elements are wired similarly to the LED tape described above, but the geometry may take some twists and turns as needed to fulfill the goal of connecting them all to the same bus and in a sequence that is logical to the end user.

In a fourth example, the systems and processes described herein can be used to control a collection of conventional lighting fixtures whose brightness is controlled by dimmers. Though this application is less common, it is mentioned in order to illustrate the point that there are many possible lighting sources and arrangements to which the instant description can be uniquely applied. The lighting fixtures may be attached to any hardware or framework that is capable of holding them safely. Each lighting fixture is wired to a uniquely addressed dimmer, which is referred to as the DMX 512 protocol for theatrical dimming, such that the result is a large and bright set of monochrome pixels. The systems and processes handle the control of these elements with equal facility and speed, irrespective of the physical configuration in which they are placed.

Generally speaking, the software application executing the Pixel Mapping system and process described herein can control RGB, or any permutation of that combination of colors, RGBW, or all-White pixels.

Returning now to FIG. 1, at the start 100 of the Pixel Mapping process according to this exemplary embodiment, a determination is made as to whether or not the control points of the LED elements need to be changed in order to create a desired image or shape upon the underlying substrate, as indicated in step 105. Multiple times per second, the system evaluates whether it needs to update the mapping. This may happen when a user drags the control points of an existing LED strip, adds control points, adds or removes an LED strip, or any other similar action that modifies the LED positions. Any changes to the DMX addresses also invalidate the current mapping. For example, a user can decide to move a LED strip from universe 1 to universe 2. Finally, changing the number of LEDs invalidates the existing mapping. If a change in the control points is not required, the process proceeds directly to step 130, whereby an output DMX control protocol is initiated as described in further detail below. If a change in the control points is required to update the mapping, the software application computes, at step 110, the Bezier segments interconnecting all control points by interpolating two more control points for each original point. At this juncture, it is important to note that with respect to the instant description, a Bezier curve is a vector-based object, but not just a single vector that goes from a point A to a point B, as the curves and loops have three (3) to an “n” number of points (whereby the number “n” is any integer number greater than 3). For each Bezier segment, a start point, an end point, and two additional control points may be used to smooth the resulting curve in order to achieve a natural feel or effect. Next, at step 115, the software application locates the two-dimensional position of each LED element, based upon the assumption that the LED elements are positioned at equal distances from each other. At step 120, once the positions of the LED elements are known, the Bezier segments are then integrated with a very high level of precision by using a numerical approximation algorithm, such as Simpson's Rule. Assuming the LED elements are spaced equally along the curve, a small distance is traveled each time to get the two-dimensional coordinate. Finally, the resulting new LED positions are then stored at step 125 for their fast retrieval. The storing order is very important to achieve high performance with modern computers.

To create the lighting effect or image presented by the source media using the LED elements, an output DMX control protocol is initiated at step 130. First, at step 135, the pixel position of each LED of the source media is computed by interpolating (using, for example, a fast linear interpolation method) its previously computed position relative to the actual dimensions of the media. The interpolation is necessary due to the fact that the media source dimension may be different than the base dimension used to compute the mapping previously. In other words, the pixel position of each LED element is scaled to fit the media dimension and then rounded to the closest integer. Because the media can be changed dynamically, only the final output dimension is known at this stage. Thereafter, at step 140, the RGB color on the source media is taken at each interpolated LED position. Multiple transformations may be applied to the RGB color at this point. For example, an RGB color filter can be applied to adjust the output color in real-time. Another transformation is to multiply all components by the same ratio to adjust the general intensity level.

However, the LED fixtures can use color representations other than RGB. Other common representations are RGBW, RGBA, and White only. In these cases, a conversion algorithm must be applied. If the color is determined to be RBG format (see step 145), the requisite colors are then written to the DMX buffer at step 180. However, if the color is to be of RGBW format (see step 150), the white value is computed by converting from the RGB to the HSL color space (see step 155), taking the ratio of the saturation and the lightness to obtain the white level (see step 160), and subtracting the white from the original RGB color (see step 165), at which point the requisite colors are written to the DMX buffer at step 180. In a third possibility, if the color is deemed to be of White format (see step 170), the white value is computed by using the Luma formula at step 175 and, subsequently, at step 180, the requisite colors are written to the DMX buffer. As a result of this process, the LED elements produce an accurate, natural-appearing, and high resolution image corresponding to the source media irrespective of the shape and contours of the substrate underlying the LED elements. Furthermore, certain features may be implemented with respect to the output resolution. For example, in one exemplary embodiment, a White, RGB, or RGBW color representation may be outputted in 16-bit resolution by sending two DMX slots for each color, rather than just one. The result is a higher resolution—not from a spatial perspective, but from a precision of intensity perspective. Accordingly, due to the greater amount of detail, smoother fades and a tighter granularity of the image rendering is achieved. Thus, the higher precision is particularly beneficial when fading and mixing media.

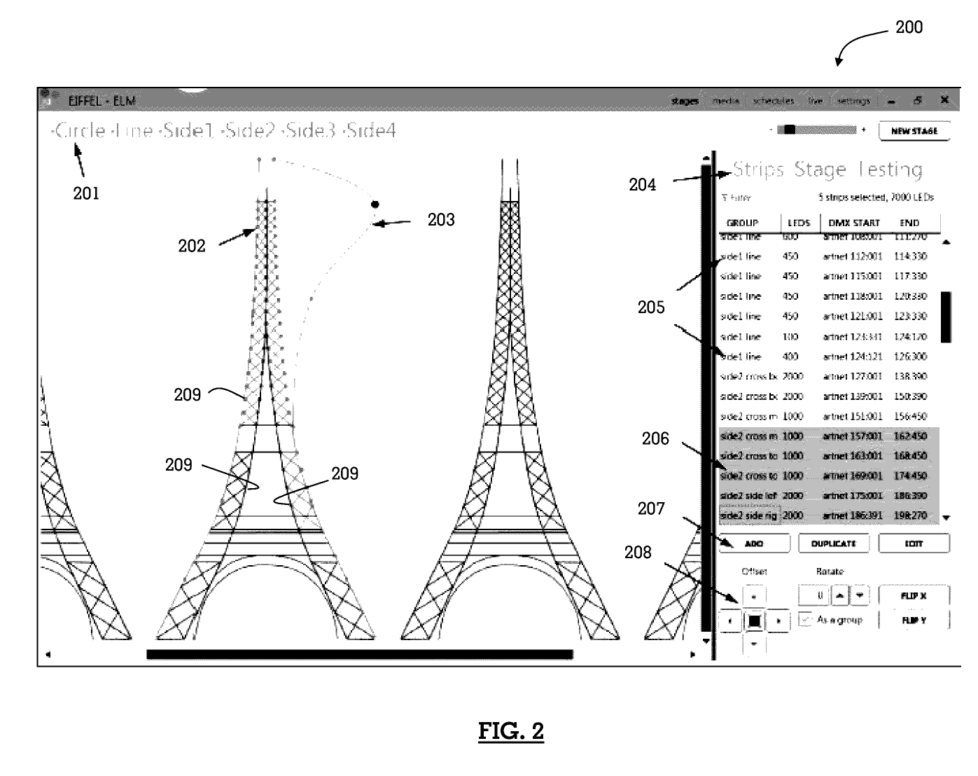

FIG. 2 depicts an exemplary embodiment of a stage strip display screen 200, which is displayed to a user through a graphical user interface of the software application described herein. The design process of the LED positioning is carried out by the user through this interactive stage strip display screen in conjunction with the Pixel Mapping process described above and executed by way of the software application. In this particular illustrative example, the user is designing an LED installation for applying to the Eiffel Tower. The stage strip display screen provides the user with a vast amount of design functions. For example, at the top left of the screen 200, there is provided a list of stages 201 from which the user can select, in which the order in the list is prioritized from left to right and top to bottom (if needed). Accordingly, the user is allowed to stack a plurality of images in a meaningful way, a layer at a time. Because the LED elements may be affiliated with more than one stage, complex combinations are possible. The current stage to be viewed or edited is selected by the user from the list 201. Because the priority of stages proceeds left to right, top to bottom, the user may optionally drag a stage into a new position in the list, but otherwise, the list 201 accretes in order of stage creation.

A stage may have a background comprised of a nonfunctional reference image 202 for use in positioning the LED elements 209 (e.g., LED strips). In this example, the reference image 202 is that of the Eiffel Tower. Currently, LED strip 203, which is built around a Bezier curve according to the Pixel Mapping process described above, is being edited. As depicted, the curve can be pushed and pulled at various control points to allow the curve to follow many different naturally occurring and man-made shapes, such as the trusses of the Eiffel Tower. At the far right of the stage strip display screen 200, there are provided a plurality of selectable buttons 204 that facilitate the design process, whereby the selection of a button generates a corresponding table or other window immediately below the button. In this particular embodiment, the buttons 204 are labeled as “Strips,” “Stage,” and “Testing.” With respect to the “Strips” button, when LED elements are added to the installation design, they appear in the main Strips table (see 205). The table provides information about the LED elements. In this particular embodiment, the table references the informal name of the strip of LEDs, the number of pixel elements in the group, and their DMX and ending addresses, which additionally allows for the table to be filtered to a limited subset, if desired. Within the Strips table, there are also buttons 207 that enable the user to add new LED strips, duplicate the strips that are selected, or edit them. As shown at the bottom of the table, there is highlighted the LED strips that are present in the Stage image currently selected (see 206). Accordingly, the Editing or Duplicating function will affect a known subset of strips within the whole. In addition to the “Add,” “Duplicate,” and “Edit” buttons, there are various tricks present to resize, reposition, rotate and flip the selected LED elements (see 208). Further, in one exemplary embodiment, a selectable feature is provided that allows the user to bundle multiple strips together to create a single entity.

In addition, a number of features may be implemented to improve usability. For example, a snap to grid may be provided in which a grid is displayed to aid in positioning the control points and strips. Also, in one exemplary embodiment, there is an option to make visible a range circle around a first control point to allow for easy positioning of other control points at equal distance(s) in order to make strips of the same length. Further, the movement of a strip may be conducted by right-clicking on the strip and dragging it to the desired position. Additionally, control points may be automatically aligned along a straight line by, for example, holding the SHIFT key while dragging.

In order to avoid accidental or inadvertent modifications, there is the option to lock the stages. Additionally, in an exemplary embodiment, the user is able to save a live panel state in a project file and restore it upon load.

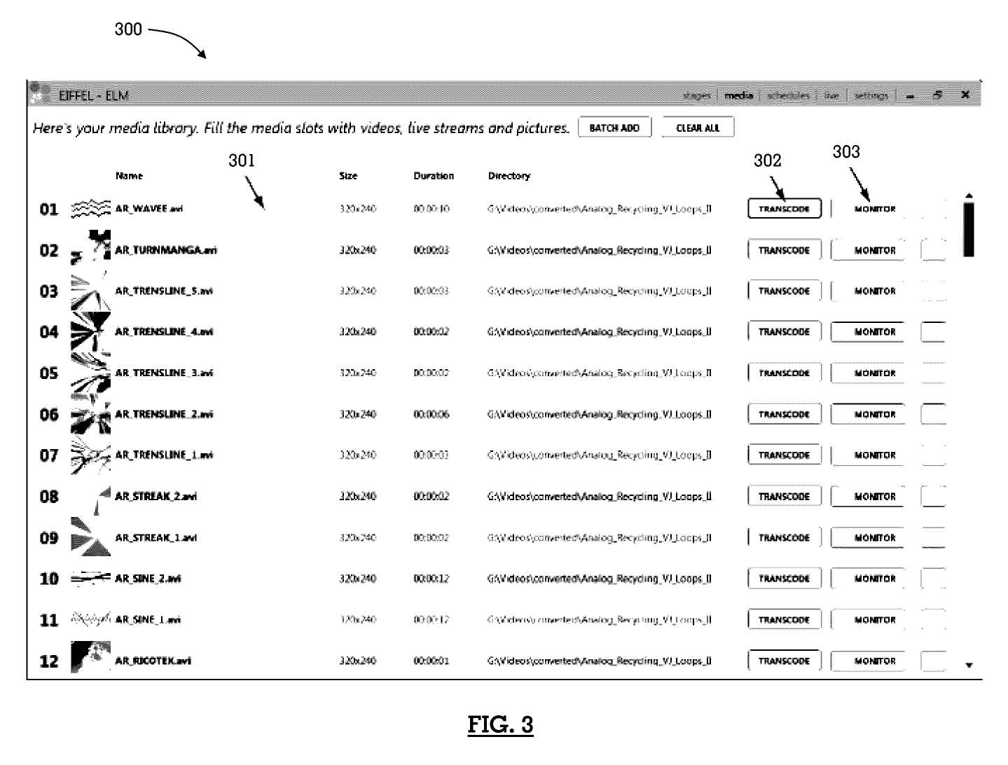

Turning to FIG. 3, there is shown an exemplary embodiment of a media library screen 300, which is displayed to a user through a graphical user interface of the software application described herein. As mentioned above, the media library allows a user to add or select from a large number of different media elements. These media elements include, but are not limited to, video files, still images, a camera feed, a live stream of a video being captured somewhere else, etc. As depicted in FIG. 3, an inventory of the available media files 301 are enumerated in the media library 300. In connection with each corresponding media file 301, there is provided a “Transcode” function 302 and a “Monitor” function 303. The “Transcode” function 302 allows a user to transcode a media file into a different format for more advantageous matching of resolution and frame rates, etc. The “Monitor” function 303 allows a user to open a window that shows the media element in a plain rectangle for monitoring it “before” the processing occurs.

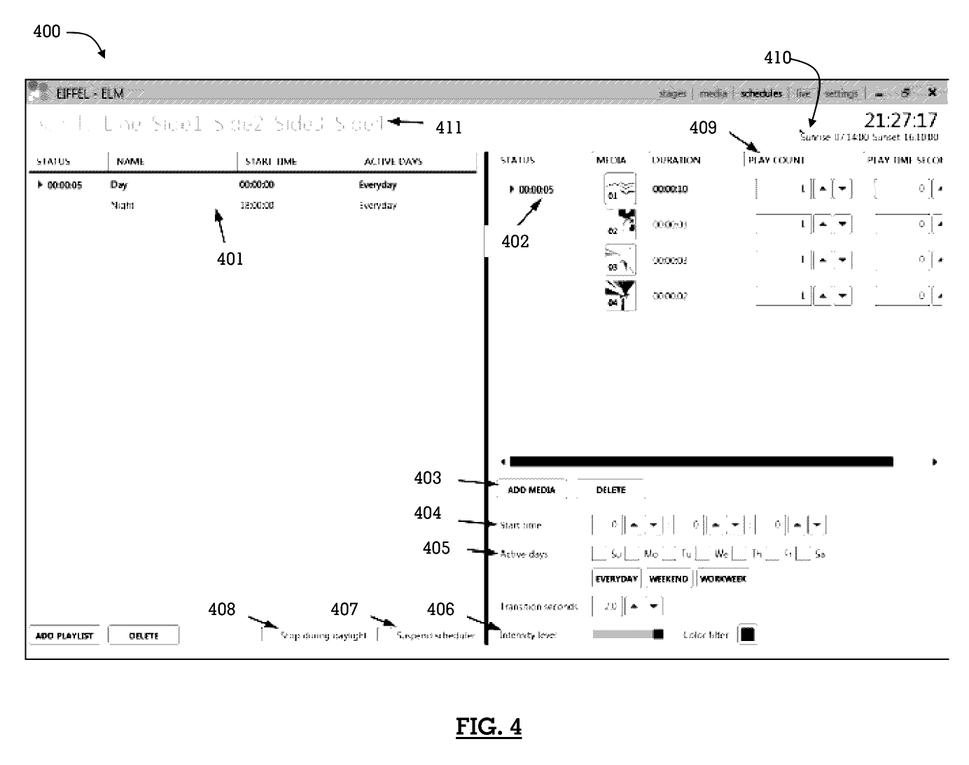

In addition, there is provided a scheduler function in order for a user to effectively manage the use of the media elements. Depicted in FIG. 4 is an exemplary embodiment of a schedules screen 400, which is displayed to a user through a graphical user interface of the software application described herein. The schedules screen 400 allows for the creation of a plurality of playlists 401, if desired. These playlists 401 comprise sequences of media in a predetermined order, with or without built-in repetition. For example, a playlist may be configured to loop (i.e., repeat) or may be configured for only a single play. A number of different playlists can be created to do different things at different times on the same stage. On the right side of the screen, the media elements 402 selected for a particular playlist are graphically displayed in the chronological order in which they will be played. In connection with each playlist, there is provided an “Add Media” function and a “Delete” function 403 by which media elements can be added or deleted from the playlist, respectively, thereby allowing the playlist to be easily revised. Further, associated with each playlist are timing parameters. For example, the playlist may have a user-set “Start Time” 404 at which the playlist will begin and a user-set period or days of the week during which the playlist will be active (see 405). In addition, a playlist may have a user-set start and end dates, thus allowing for scheduling a playlist to be active on a specific date or during a certain period of the year. This feature is especially advantageous for permanent lighting installations. Furthermore, the duration of a playlist may be set by the user, thereby improving the ability to stop a playlist after a specific duration without the need to start an empty playlist to do so. Also, the user is allowed to adjust an intensity setting and to apply a color filter to the playlist (see 406). When desired, a user may suspend 407 operations of all playlists to create a spontaneous display, or to aid in resetting everything for testing purposes. Additionally, all playlist activity can be selectively turned off 408 during, for example, between dawn and dusk, thus allowing for this rapid energy saving option to be implemented with a single button selection. The timing of the running of each media element 409 within a playlist can also be adjusted, either with time basis limiting or with iteration limiting. Further, the local time and sunrise/sunset times are displayed to conveniently assist the user in planning the timing of the playlist. Also, a user may select between different stages 411, such that each stage has the potential to have different playlists associated with it.

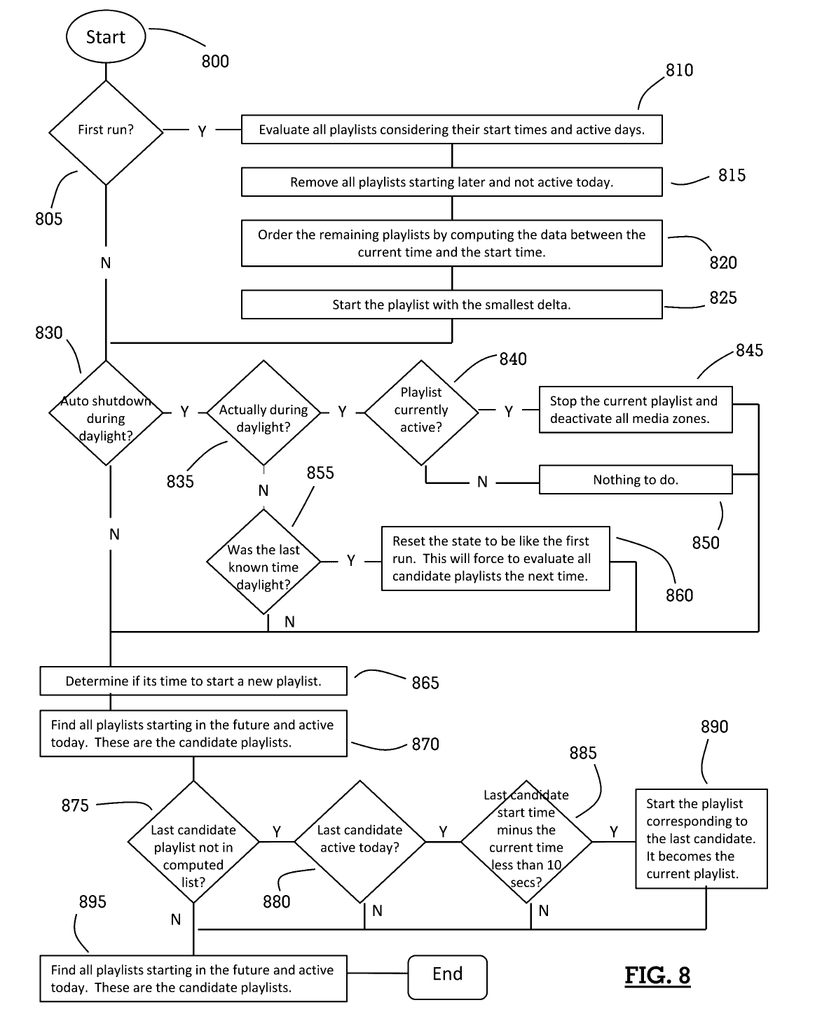

FIG. 8 provides a flow chart that is illustrative of an exemplary embodiment of a scheduler function. In this particular embodiment, one scheduler is active for each stage. As described above, a stage can have multiple playlists that are programmed to start at certain hours and days. Another aspect required for lighting installations is the automatic suspension during daylight. Accordingly, in a continuous fashion, a determination is made as to what should be the active playlist and whether or not it should be suspended. At the start 800 of the process, for example at start-up or when resuming, an initial evaluation 805 is performed in which all playlists are evaluated (see step 810) with respect to their start times and active days. That is, all playlists starting later than the current time and not active on the current day are removed (see step 815). Subsequently, the remaining playlists are placed in order by computing 820 the delta Δ between the current time and the start time. Finally, the playlist with the smallest delta Δ is started (see step 825).

In addition, if the light output should be suspended during daylight (see step 830), a determination is first made if it is currently daylight (see step 835). For this purpose, mathematical equations are used to compute the position of the sun at a given time of day and a specific coordinate on Earth. If it is currently daylight and a playlist is active (see step 840), the active playlist is suspended and all media zones are deactivated (see steps 845 and 850). However, if it is not during daylight, but the last known time it was during daylight, then it is presumed that sunset has just passed (see step 855) and, therefore, scheduling can be resumed by resetting 860 the state to that which was present at the first run. This will force the evaluation of all candidate playlists during the next evaluation process.

The next step is to determine if it is time to start a new playlist (see step 865). For this purpose, all playlists starting in the future and active for the current day are identified (see step 870). These playlists are the candidate playlists. Next, a consideration is made as to what the candidate playlist was the last time this evaluation was performed. If this candidate playlist isn't in the candidate list (see step 875), but is active for the current day and its start time minus the current time is less than 10 seconds, then the candidate playlist is started and it becomes the current playlist (see steps 880, 885, and 890). The new candidate playlist becomes the playlist in the candidate list with the closest start time to the current time. This process is continued for all identified candidate playlists (see step 895).

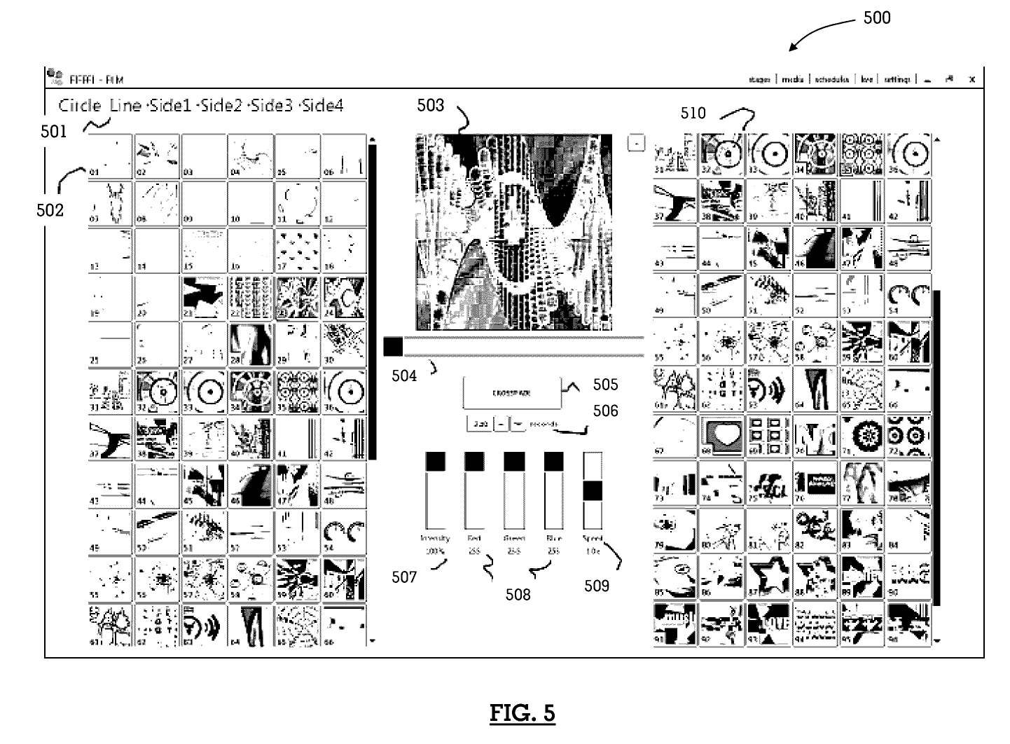

Advantageously, the user is also provided with a live control function. For example, there is depicted in FIG. 5 an exemplary embodiment of a live control screen 500, which is displayed to a user through a graphical user interface of the software application described herein. Specifically, the live control screen 500 allows a user to select the stage 501 on which they wish to manipulate media. It is further subdivided, regardless of which stage is selected, into a left and right panel for selecting media elements and a central control area. The left panel 502 provides a scrollable selection of thumbnail sized buttons that each correspond to a selectable media element. The central area of the live control screen 500 features a preview area 503 that shows the exact mixture of media elements being sent to the stage by whichever settings are manipulated everywhere else on the live control screen 500. There is also provided a crossfade bar 504, which allows a user to manually slide from left to right, to thereby gradually move through the complete transition from 100% of the left-panel (502) media element to 100% of the right-panel (510) media element, or any proportional mixture of the two sides. Further, a crossfade button 505, when activated, executes a timed automatic crossfade from the presently selected side all the way to the other side. Turns are taken between left and right according to the time selected in the appropriate box 506 that is positioned nearby. When these crossfades occur, they automatically and correspondingly move the crossfade bar 504. Furthermore, a user can set the duration of the crossfade (see 506), which takes place once the crossfade button 505 is activated. In addition, the intensity can be manipulated by the user either by directly moving a slider 507 or by remote control from another location using a method such as DMX or DMX-over-Ethernet, according to an exemplary embodiment. The intensity refers to the brightness sent as a master level of all colors allowed to pass from the live control area for the presently selected stage. The software application mixes these stages together according to an algorithm, such as from left to right, but other permutations are possible. The resulting data is then sent to a DMX buffer whereby the data is formatted and sent to the network for distribution to the lighting elements. Color filters may also be applied for each stage such that, instead of a full color spectrum, a particular set of tints and hues can be favored. In this particular embodiment, three adjustable sliders 508 each control one of the three primary colors (Red, Green, and Blue) and may be adjusted by the user. In fact, a multitude of transition effects may be selectable by the user. For example, color crossfade may be implemented between playlist items by using the color filters and the transition duration. As mentioned above, remote control by DMX or other method is a feature that can be enabled, if a user wishes to take over operation from a different location or by way of a different control apparatus, such as a traditional lighting console. As such, various transition effects can be selected in playlists and via the remote control for implementing the transitions or applying effects at any time. Furthermore, the speed of the playback of a selected media element of a selected stage is also adjustable by the user using the adjustable slider 509. This control feature is also remotely controllable in a way similar to the intensity and color. The right panel 510 of the live control screen 500 allows a user to select a media element such that, when the crossfade controls are employed (as described above), this second media element selected from the right panel 510 may be mixed with the first media element selected from the left panel 502. In an exemplary embodiment, the user is provided with an extended DMX remote control mode comprising a 16-bit dimmer and the ability to individually control the media and speed of the A and B sides, and to select a mix/transition effect.

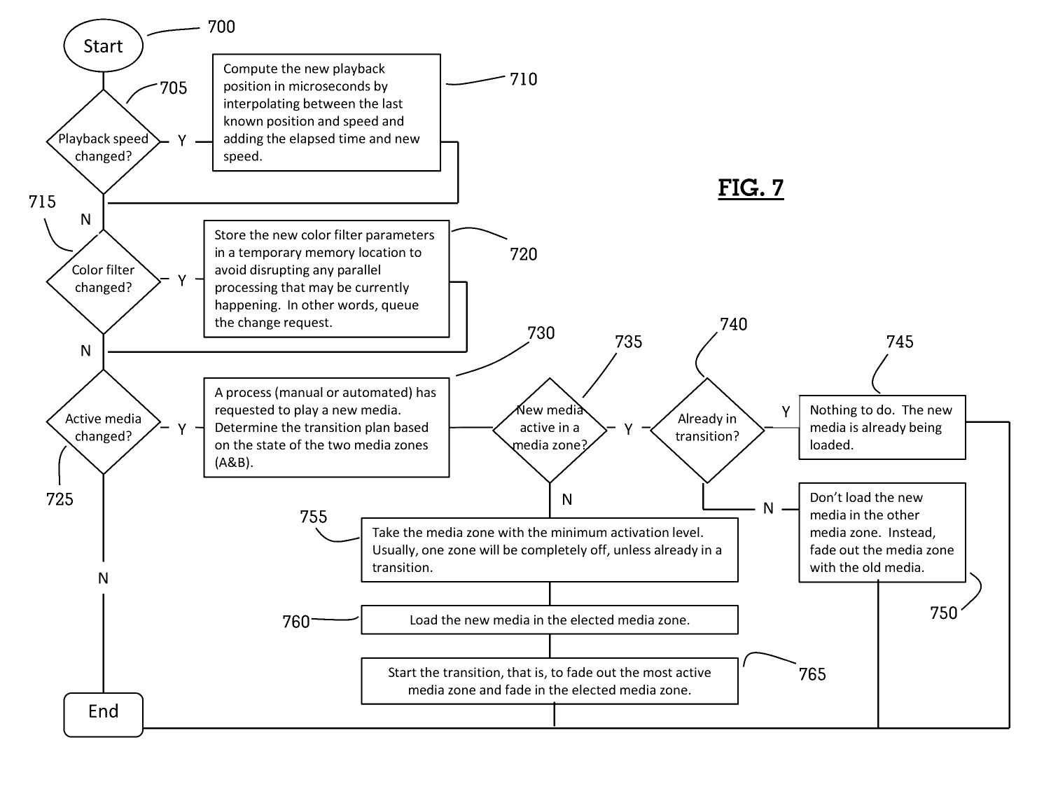

In FIG. 7, there is depicted a flow chart of an exemplary embodiment of a process in which the user applies the live control functions. Beginning at step 700, in a continuous fashion, a determination is made as to whether or not the playback speed has changed (see step 705). If the playback speed has changed, the new playback position is computed 710 in microseconds by interpolating between the last known position and speed and adding the elapsed time and the new speed.

Thereafter, a determination is made as to whether the desired color filter has changed (see step 715). A color filter is constituted of a Red, Green, and Blue (RGB) component. Each component multiples the RGB pixels of the media sources in real-time. When it has been updated, the new color filter parameters are stored 720 in a temporary memory location to avoid disrupting any parallel processing that may be currently happening. In other words, the change request is queued. The new color filter will be used the next time there is an output to the DMX buffer.

Continuing on, a determination is made as to whether or not the active media needs to be changed (see step 725). For example, such a change occurs when the user selects a new media element or when another lighting console triggers this change. In such an instance, the transition plan must be determined based on the state of the two media zones (A&B) (see step 730). If a new media is already active in a media zone (see step 735), then the other media zone is deactivated (see steps 740, 745, and 750). Otherwise, the media zone with the minimum activation level is selected at step 755. Usually, one zone will be completely off, unless a transition is already in process. Thereafter, the new media is loaded 760 in the selected media zone. At this point, the transition can start in order to fade out the most active media zone and fade in the selected media zone (see step 765).

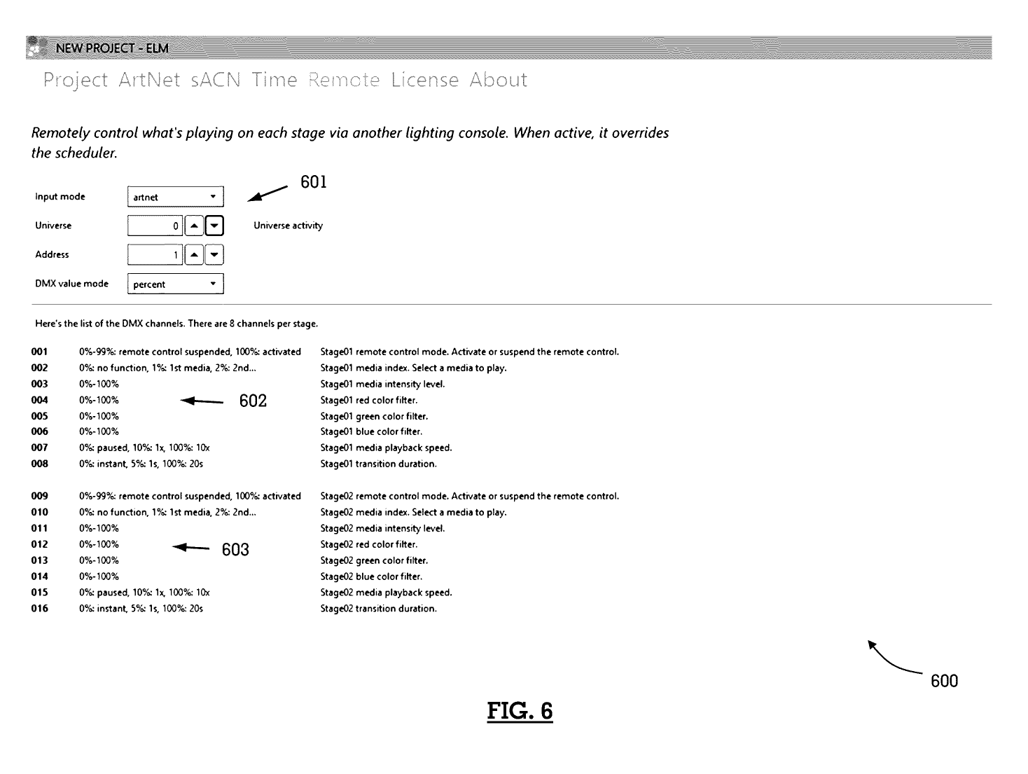

With respect to FIG. 6, there is depicted an exemplary embodiment of a remote screen 600, which is displayed to a user through a graphical user interface of the software application described herein. This remote control screen allows a user to stipulate how the arrangement of remotely accessible parameters are to be laid out, and where they will be located within the wider context of the protocol that is chosen to manipulate them. The remote control screen displays a list to the user of what the specific number for each parameter will be, organized a stage at a time. These parameters correspond to the control area of the live control screen 500, i.e., intensity 507, colors 508, and speed 509, and additional elements are available as well for selecting the media elements in question for each side panel. The top band 601 of the remote control screen 600 illustrates the ability to specify one of several different input modes. In this particular embodiment, the art-net mode is shown by way of illustration. However, other protocols, such as sACN and KiNet are also supported, as are certain hardware interfaces that use the USB standard to mediate between the computer and a lighting console that may be used to send the control signals to this program. Using art-net, again by example, there are hundreds of universe/subnet combinations to choose from and a starting address is selectable, too, as is customary for DMX 512 devices. In the lower band 602 of the remote control screen 600, there is displayed a list of all the DMX channels that are assigned to various functions that can be remotely controlled. In this particular embodiment, the first two channels are related to activity and media element selection. The following five channels are similar to the faders (507, 508, and 509) provided in the center panel of the live control screen 500. Lastly, the eighth channel, which is labeled as “Transition Duration,” is related to the crossfade time 506, but allows for a gradual change between media elements when the remote control is being employed. The controls provided in area 602 of the remote control screen 600 are dedicated to a first stage of the design project. An additional area 603 of the remote control screen 600 provides a set of dedicated controls for a next stage, such that the next stage is provided with its own set of DMX channels by which its attributes can be controlled. Additional areas may be created until all stages of the design project are accounted for.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems, apparatuses, and methods as defined by the following claims.

What is claimed is:

1. A pixel mapping method for transferring an electronically generated image onto a physical substrate upon which a plurality of lighting elements are applied, the method comprising:
changing a plurality of control points associated with each of the plurality of lighting elements by:
computing the Bezier segments interconnecting all of the plurality of control points by interpolating two or more control points for each original control point, whereby each Bezier segment is computed using at least a start point, an end point, and two additional control points in order to smooth a resulting curve;
locating a two-dimensional position of each of the plurality of lighting elements based upon an assumption that the lighting elements are positioned at equal distances from each other;
integrating the Bezier segments by using a numerical approximation algorithm to determine a new two-dimensional position of each of the plurality of lighting elements; and
storing the new two-dimensional positions of the plurality of lighting elements; and
initiating an output DMX control protocol by:
computing a pixel position for each lighting element of a source media by interpolating the lighting elements' previously computed pixel position relative to actual dimensions of the media;
applying RGB colors on the source media at each interpolated pixel position; and
writing the colors to a DMX buffer.

2. The method according to claim 1, wherein the plurality of lighting elements are comprised of light-emitting diodes (LEDs).

3. The method according to claim 1, wherein the numerical approximation algorithm utilized in the integrating step is derived from Simpson's Rule.

4. The method according to claim 1, wherein the computing of the pixel position for each lighting element is performed using a fast linear interpolation method.

5. The method according to claim 1, further comprising applying a transformation to the RGB color prior to writing the colors to the DMX buffer by using a conversion algorithm to obtain one of the following color formats:
RGBW; and
White.

6. A method for updating a pixel map for transferring an electronically generated image onto a physical substrate upon which a plurality of lighting elements are applied, the method comprising:
determining that a modification of a position of at least one lighting element of the plurality of lighting elements has occurred;
changing a plurality of control points associated with each of the plurality of lighting elements by:
computing the Bezier segments interconnecting all of the plurality of control points by interpolating two or more control points for each original control point, whereby each Bezier segment is computed using at least a start point, an end point, and two additional control points in order to smooth a resulting curve;
locating a two-dimensional position of each of the plurality of lighting elements based upon an assumption that the lighting elements are positioned at equal distances from each other;
integrating the Bezier segments by using a numerical approximation algorithm to determine a new two-dimensional position of each of the plurality of lighting elements; and
storing the new two-dimensional positions of the plurality of lighting elements.

7. The method according to claim 6, wherein the plurality of lighting elements are comprised of light-emitting diodes (LEDs).

8. The method according to claim 6, wherein the numerical approximation algorithm utilized in the integrating step is derived from Simpson's Rule.

9. The method according to claim 6, further comprising using the resulting updated pixel map to create a resulting lighting effect or image presented by a source media by:
initiating an output DMX control protocol by:
computing a pixel position for each lighting element of the source media by interpolating its previously computed pixel position relative to actual dimensions of the media;
applying RGB colors on the source media at each interpolated pixel position; and
writing the colors to a DMX buffer.

10. The method according to claim 9, wherein the computing of the pixel position for each lighting element is performed using a fast linear interpolation method.

11. The method according to claim 9, further comprising applying a transformation to the RGB color prior to writing the colors to the DMX buffer by using a conversion algorithm to obtain one of the following color formats:
RGBW; and
White.

12. A method for updating a pixel map for transferring an electronically generated image onto a physical substrate upon which a plurality of lighting elements are applied, the method comprising:
modifying a position of at least one lighting element of the plurality of lighting elements;
determining that the modification of the position of the at least one lighting element requires the pixel map to be updated;
changing a plurality of control points associated with each of the plurality of lighting elements by:
computing the Bezier segments interconnecting all of the plurality of control points by interpolating two or more control points for each original control point, whereby each Bezier segment is computed using at least a start point, end point, and two additional control points in order to smooth a resulting curve;
locating a two-dimensional position of each of the plurality of lighting elements based upon an assumption that the lighting elements are positioned at equal distances from each other;
integrating the Bezier segments by using a numerical approximation algorithm to determine a new two-dimensional position of each of the plurality of lighting elements; and
storing the new two-dimensional positions of the plurality of lighting elements.

13. The method according to claim 12, wherein the plurality of lighting elements are comprised of light-emitting diodes (LEDs).

14. The method according to claim 12, wherein the numerical approximation algorithm utilized in the integrating step is derived from Simpson's Rule.

15. The method according to claim 12, further comprising using the resulting updated pixel map to create a resulting lighting effect or image presented by a source media by:
initiating an output DMX control protocol by:
computing a pixel position for each lighting element of the source media by interpolating its previously computed pixel position relative to actual dimensions of the media;
applying RGB colors on the source media at each interpolated pixel position; and
writing the colors to a DMX buffer.

16. The method according to claim 15, wherein the computing of the pixel position for each lighting element is performed using a fast linear interpolation method.

17. The method according to claim 15, further comprising applying a transformation to the RGB color prior to writing the colors to the DMX buffer by using a conversion algorithm to obtain one of the following color formats:
RGBW; and
White.
